(19) United States
(12) Patent Application Publication
(10) Pub. No.: US 2026/0307586 A1
(43) Pub. Date: Oct. 8, 2026

(54) METHOD FOR MAINTAINING COMMUNICATION BETWEEN A CONTROL UNIT AND LIGHTING DEVICES OF A MOTOR VEHICLE, AND MOTOR VEHICLE

(71) Applicant: AUDI AG, Ingolstadt (DE)

(72) Inventors: Christoph KENN, Gaimersheim (DE); Alexander FECHNER, Berching (DE)

(21) Appl. No.: 19/638,021

(22) Filed: Apr. 2, 2026

(30) Foreign Application Priority Data
Apr. 7, 2025 (DE) 102025113607.6

(51) Int. Cl. B60Q 11/00; B60R 16/023

(52) U.S. Cl. CPC B60Q 11/002; B60R 16/0232; B60R 16/0238

(57) ABSTRACT

A method for maintaining a communication link between a control unit and lighting devices in a motor vehicle, wherein the motor vehicle includes the lighting devices and the control unit, wherein control commands generated by the control unit for controlling the lighting devices are transmitted from the control unit to the lighting devices by way of a vehicle bus, wherein the control device and each of the lighting devices are connected by way of a separate data line, wherein, in the event of a defect in the vehicle bus, the control commands and/or fault control commands generated by the control device for controlling the lighting devices are transmitted to the respective lighting device via at least one of the data lines.

### BACKGROUND

### Technical Field

The present disclosure relates to a method for maintaining a communication link between a control unit and lighting devices in a motor vehicle, wherein the motor vehicle comprises the lighting devices and the control unit, and wherein control commands generated by the control unit for controlling the lighting devices are transmitted from the control unit to the lighting devices by way of a vehicle bus.

### Description of the Related Art

In modern vehicles, lighting devices such as headlights are controlled to realize various lighting functions by generating control commands that trigger the respective lighting function from a control unit that realizes a master control unit and transmitting them via a vehicle bus to the respective lighting device or a control device of the lighting device that implements a slave control unit. The control device acts as a power driver to supply light sources of the respective lighting device with electrical power.

Problematic in this case are defects in the vehicle bus, such as a power or bus failure, in which case corresponding lighting functions must be activated by the control devices themselves or redundancy in the communication connection is provided. Systems with such redundancy are described in DE 101 54 983 A1 and DE 10 2010 044 800 A1.

### BRIEF SUMMARY

The disclosure provides an improvement in maintaining the communication link between the control unit and the lighting devices of a motor vehicle, in particular with regard to the most reliable and situation-specific advantageous mode of operation possible.

Embodiments of the disclosure connect the control unit and each of the lighting devices by way of a separate data line, wherein, in the event of a defect in the vehicle bus, the control commands and/or fault control commands generated by the control unit for controlling the lighting devices are transmitted to the respective lighting device via at least one of the data lines.

The disclosure is based on the idea of providing a data line between the control unit on the one hand and each of the lighting devices on the other, which connects the control unit and the respective lighting device to each other in pairs. In fault-free operation of this system architecture, in which the vehicle bus operates without restrictions or defects, the communication link between the control unit and the lighting devices, i.e., the transmission of control commands, is advantageously carried out exclusively via the vehicle bus. If a defect occurs in said vehicle bus, for example due to mechanical damage, the data lines still allow the control commands or fault control commands to be transmitted from the control unit to the lighting devices. As the lighting devices are each connected separately to the control unit, they can also be controlled individually. The data transmission from the control unit to the lighting devices, which takes place despite the defect in the vehicle bus, is particularly advantageous in the event of an accident, as the operation of the lighting devices can be ensured by way of the control commands or fault control commands transmitted via at least one of the data lines, so that the motor vehicle remains visible to other road users in this situation, especially in the dark.

With regard to the data transmission via the data lines in the event of a fault, it is conceivable that the control commands transmitted here would have been transmitted via the vehicle bus even if the fault had not occurred. In addition or alternatively, the transmission of fault control commands is conceivable, which may represent control commands specifically intended for the occurrence of the fault. For example, the fault control commands could trigger the activation of a warning light, such as a hazard warning light, by way of at least one of the lighting devices. In this case, the fault control commands could be toggling signals that cause the warning light to flash.

At least one of the data lines may comprise at least one power cable or at least one fiber for transmitting optical signals. If bidirectional communication is to be enabled via at least one of the data lines, said data line can also be formed as a multi-wire line. The routing of the data lines in the vehicle can be such that it bypasses the area in which the vehicle bus is located, so that the data lines are not necessarily affected in the event of mechanical destruction of the vehicle bus. In other words, the data lines advantageously have a minimum distance to the components forming the vehicle bus at each point, which can be at least ten centimeters, for example.

The control unit, which can also be referred to as a master control unit, can be an HCP4 control unit. The control unit can be configured to generate the control commands on the basis of specifications generated by a driver and/or a vehicle control system of the motor vehicle and to output them to the respective lighting devices.

Light can be generated and emitted by way of the lighting devices. The lighting devices can also be referred to as vehicle headlights or vehicle lights. The lighting device comprises at least one illuminant, preferably in the form of a light-emitting diode, which can be controlled with regard to its operation by way of the control device of the respective lighting device, which control device can also be referred to as a power driver and be present as an LSG device. The control can be directed at the brightness and/or color of the light to be generated. The at least one illuminant, which can also be referred to as a light source, can be arranged on a circuit board, which can be a printed circuit board. Optionally, the electronic components forming the control device are also arranged on the circuit board, preferably on the side of the circuit board facing away from the at least one illuminant. Components of the lighting device, such as the illuminants and possibly the circuit board and the control device, can be arranged inside a housing of the respective lighting device.

The lighting devices may be front headlights and/or rear headlights of the motor vehicle. In particular, at least one lighting device is provided on the left-hand side and at least one on the right-hand side of the motor vehicle, which are connected to the control unit via separate data lines.

The vehicle bus, which can also be referred to as a data bus, is preferably a CAN bus. The vehicle bus enables the transmission of control commands. Generally speaking, the vehicle bus realizes a common data transmission path for several participants, in this case at least for the control unit and the lighting devices. If data transmission is currently taking place between two participants, further data transmissions are postponed until this data transmission has been completed.

It is conceivable that each of the lighting devices has a control device by way of which at least one illuminant of the respective lighting device is controlled by way of the control commands and/or the fault control commands of the control device, wherein the vehicle bus and the data lines connect the control unit to the control devices. The control commands can thus define or specify the lighting function currently to be implemented by way of the lighting device, wherein the specific control of the at least one illuminant is carried out as a function thereof by way of the control device of the respective lighting device. With regard to the light functions, a high beam, low beam or indicator light can be generated.

According to the disclosure, it may be provided that at least one of the lighting devices, in particular by way of the respective control device, checks for the fulfillment of a fault condition which is fulfilled if there is a defect in the vehicle bus, wherein, in the event of fulfillment of the fault condition, a fault signal is generated which is transmitted to the control unit via at least one of the data lines and which causes the control commands and/or the fault control commands to be transmitted to the respective lighting device via the data line. In this way, in the event of a fault, at least one of the lighting devices will detect a defect in the vehicle bus. Since fault-free data transmission via the vehicle bus cannot be assumed in this case, the fault signal generated by the lighting unit is transmitted via the data line connected to that lighting unit. If the fault signal is present, the control unit is configured to terminate data transmission via the vehicle bus and instead transmit the control commands and/or the fault control commands to the respective lighting device via at least one of the data lines.

As part of a possible further development, it is provided that an absence check is carried out with regard to the control commands, wherein the fault condition is fulfilled if the absence check reveals that the control commands were not received by at least one of the lighting devices. In other words, at least one of the lighting devices checks whether expected control commands are actually received via the vehicle bus, wherein otherwise it is assumed that the vehicle bus is defective, which in turn triggers the generation of the fault signal. It is therefore conceivable that, in the event of proper or fault-free data transmission from the control unit to the lighting devices, a termination signal is transmitted from the control unit to the at least one lighting device via the vehicle bus when the transmission of the control commands is terminated, for example when a lighting function to be implemented is terminated. In this case, the fault condition can be fulfilled if the termination signal is not present and no further control commands have been transmitted via the vehicle bus, in particular for a specified minimum period of time.

In addition or alternatively it is also conceivable that a plausibility check is performed regarding the control commands, wherein the fault condition is fulfilled if the plausibility check reveals a lack of plausibility in the control commands. It is assumed here that the control commands are transmitted via the vehicle bus, i.e., that there is no bus fault, wherein the control commands are still checked for plausibility or meaningfulness. If this is not the case, it can be assumed that there is a defect in the vehicle bus and that the fault condition is fulfilled.

Specifically, it is conceivable that, as part of the plausibility check, at least one parameter regarding the control commands will be checked to determine whether it is within a valid range, wherein the plausibility check will reveal a lack of plausibility for the control commands if the parameter is outside the valid range. The parameter can be understood to be any physical variable regarding the control commands or dependent on the control commands. The valid range is the interval for this variable or parameter within which the corresponding value lies during fault-free operation of the vehicle bus. If this value lies outside this interval, it is concluded that there is a fault in the vehicle bus, for example due to a short circuit, so that the fault condition is fulfilled in this case.

The parameter, or one of the parameters, can be a voltage level of the control commands. In addition or alternatively, the parameter, or one of the parameters, may be a duty cycle of the control commands, which are present as pulse-width modulated signals. The duty cycle, which can also be referred to as a duty factor, indicates the ratio of the pulse duration to the period duration and is typically given as a percentage. The duty cycle can act as an information carrier regarding the lighting function to be implemented. Thus, intervals for the duty cycle can each be assigned to a specific light function, wherein the respective light function is implemented when a corresponding duty cycle is present. If the current duty cycle cannot be assigned to a light function, it can be assumed that the vehicle bus is faulty, meaning that the fault condition is fulfilled in this case.

Within the framework of one conceivable embodiment, it is provided that on the part of at least one of the lighting devices, and when the fault condition is fulfilled, at least one fault information is determined which relates to a circumstance which is the cause of the defect in the vehicle bus, wherein the at least one fault information is transmitted to the control unit via at least one of the data lines. According to this design, data is not only transmitted from the control unit to the lighting device, but the fault information is also transmitted in the opposite direction. This enables the control unit to initiate a targeted measure that can be specifically provided for the respective type of fault. In this way, the control unit can be configured to generate and output control signals specifically provided for said respective fault information when said fault information is present. The control signals can trigger a corresponding countermeasure, such as generating a user output to inform the driver of the presence of the fault and, if necessary, requesting a visit to a workshop, and/or restarting the vehicle bus and/or the like.

With regard to the fault control commands, it may be possible to provide that a lighting function, realized by the control commands before the vehicle bus fault occurred, continues to function. In this case, the fault control commands ultimately correspond to the control commands, which, however, are not transmitted via the vehicle bus, but instead via at least one of the data lines. In addition or alternatively, the fault control commands may cause a fault lighting function specifically provided for the defect in the vehicle bus to be implemented. The warning light mentioned above can be generated as part of the fault lighting function.

The present disclosure also relates to a motor vehicle comprising a plurality of lighting devices and a control unit, wherein control commands generated by the control unit for controlling the lighting devices can be transmitted from the control unit to the lighting devices by way of a vehicle bus. According to embodiments of the disclosure, the control unit and each of the lighting devices are connected by way of a separate data line, wherein, in the event of a defect in the vehicle bus, the control commands and/or fault control commands generated by the control unit for controlling the lighting devices can be transmitted to the respective lighting device via at least one of the data lines. All advantages, features and aspects explained in connection with the method according to the disclosure are equally transferable to the motor vehicle according to the disclosure and vice versa.

### BRIEF DESCRIPTION OF THE SEVERAL VIEWS OF THE DRAWINGS

Further advantages, features and aspects of the present disclosure will become apparent from the exemplary embodiments set forth below and from the figures. The figures show schematically:

FIG. 1 is a schematic diagram of a motor vehicle according to the disclosure in accordance with an exemplary embodiment, and

FIG. 2 is a flowchart of a method according to the disclosure in accordance with an exemplary embodiment, which is carried out using the motor vehicle of FIG. 1.

### DETAILED DESCRIPTION

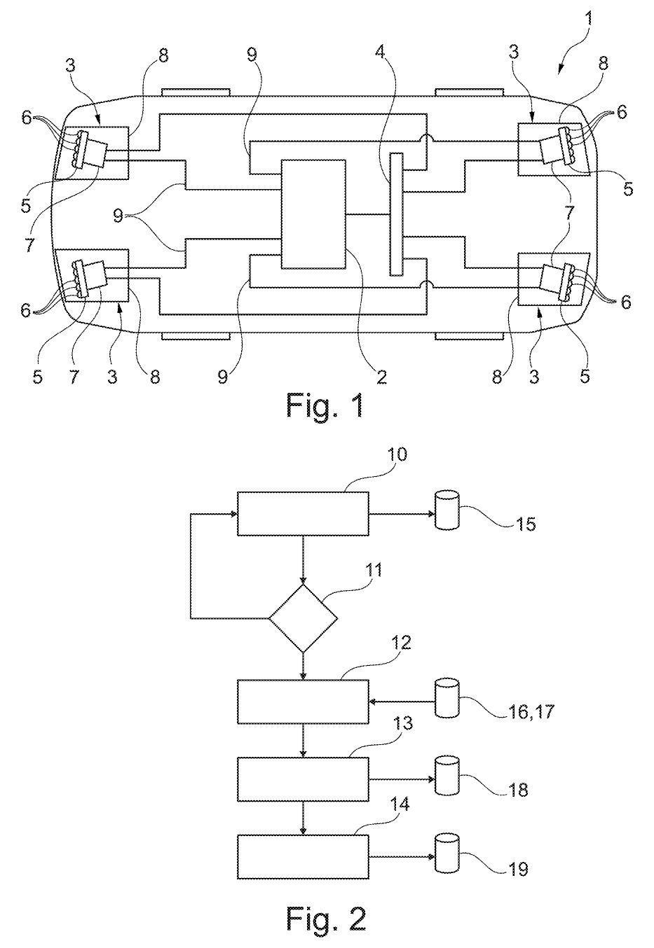

FIG. 1 shows a schematic diagram of a motor vehicle 1 according to the disclosure in accordance with an exemplary embodiment. The motor vehicle 1 comprises a control unit 2 and a plurality of lighting devices 3 connected to the control unit 2. In total, the motor vehicle 1 comprises four lighting devices 3, namely two front headlights and two rear headlights, which are each arranged on the left-hand and right-hand sides of the motor vehicle 1. The control unit 2 and the lighting devices 3 are connected via a vehicle bus 4, so that a communication link is realized between the control unit 2 and the lighting devices 3, via which communication between the control unit 2 and the lighting devices 3 takes place within the framework of controlling the lighting devices 3. The control unit 2 is configured to control the lighting devices 3 based on specifications generated by a driver and a vehicle control system of the motor vehicle 1.

The lighting devices 3 each comprise a plurality of illuminants 6 arranged on a circuit board 5 and designed as light-emitting diodes. Furthermore, the lighting devices 3 each have a control device 7, the components of which are arranged on the side of the circuit board 5 opposite the illuminants 6. The components of the control device 7 are arranged in a housing 8 of the respective lighting device 3. With regard to the connections realized via the vehicle bus 4, the control unit 2 is connected to each of the control devices 7.

Furthermore, the control unit 2 is connected to each of the lighting devices 3 or, more precisely, to each of the control devices 7 via a separate data line 9, so that, since the motor vehicle 1 has four lighting devices 3, a total of four such data lines 9 are provided.

With reference to FIG. 2, a method according to the disclosure will now be explained in accordance with an exemplary embodiment, which is carried out in the motor vehicle 1 of FIG. 1. FIG. 2 shows a flow chart of this method comprising the steps 10 to 14. In the first step 10, the already mentioned control of the lighting devices 3 is carried out by way of the control unit 2, wherein control commands 15 are generated, output, and transmitted to the lighting devices 3 via the vehicle bus 4. Based on the control commands 15, the respective control device 7 in turn generates control commands, which are used to control the illuminants 6 with regard to the color and brightness of the light to be generated. The control devices 7 act as power drivers for the respective lighting device 3.

In the next step 11, each of the control devices 7 checks whether a fault condition is fulfilled, which is fulfilled if there is a fault on the vehicle bus 4. In this respect, a line fault, for example in the case of an accident-related, mechanical destruction of vehicle bus 4, or a short circuit are conceivable. The check of whether the fault condition is fulfilled is carried out with regard to a plurality of aspects, which are discussed below.

Thus, the respective control device 7 carries out an absence check regarding the control commands 15, wherein the fault condition is fulfilled if this check reveals that the control commands 15 were not received by the lighting device 7. Thus, it is provided that, in the event of fault-free transmission of the control commands 15 from the control unit 2 to the control device 7, a termination signal is transmitted from the control unit 2 to the control device 7 via the vehicle bus 4 when the signal transmission is terminated, for example when a light function is terminated. In this case, the fault condition is fulfilled if the termination signal is not present and, in addition, no further control commands have been received by the control device 7 via the vehicle bus for a specified minimum period of time.

Furthermore, several plausibility checks regarding the control commands 15 are carried out in the course of checking whether the fault condition has been fulfilled. Specifically, physical parameters regarding the control commands 15 are checked to determine whether their values are within a valid range in which the parameters are within the framework of fault-free operation of the vehicle bus 4. Otherwise, the fault condition is fulfilled.

One of these parameters relates to an electrical voltage of the control commands 15 or, in other words, their voltage level. Another of these parameters relates to a duty cycle of the control commands 15, which are present as pulse-width modulated signals. Basically, the duty cycle acts as an information carrier regarding the control commands 15. This is illustrated below using a specific example. Accordingly, it is assumed that the control commands 15 are intended to realize a flashing function as the lighting function. A duty cycle of 25 % ± 8 % can realize a control command 15 according to which the flashing light is switched off, so that the corresponding control command 15 is present during the off phases of this flashing light. A duty cycle of 75 % ± 8 % can realize a control command 15 according to which the flashing light is switched on, so that the corresponding control command 15 is present during the on phases of this flashing light. A duty cycle of 50 % ± 8 % can imply a termination of the flashing light, so that the corresponding control command 15 can realize the termination signal mentioned above. According to these specifications, there are therefore three valid ranges for the duty cycle, namely from 17 % to 33 %, from 42 % to 58 % and from 67 % to 83 %. If the duty cycle determined falls outside these intervals, the fault condition is fulfilled, as in this case, fault-free operation of vehicle bus 4 cannot be assumed. In particular, a duty cycle of 0 % relates to the case in which no data transmission takes place. A duty cycle of 100 % indicates the presence of a short circuit.

If the check of the fulfillment of the fault condition in step 11 reveals that it is not fulfilled, the method continues with the further generation of the control commands 15 in step 10. If the fault condition is fulfilled, the next step 12 takes place in parallel, in which the control device 7 determines a fault information 16 relating to a circumstance that is responsible for the defect in the vehicle bus 4. Specifically, the fault information 16 relates to the circumstance that leads to the fault condition being fulfilled. Thus, fault information 16 indicates whether, contrary to expectations, the control unit 7 is currently not receiving any control commands 15 and/or whether the plausibility check has revealed a deviation of a parameter from the valid range, and, if so, which parameter this affects. The fault information 16 determined in step 12 is transmitted to the control unit 2 by the control device 7 from which the fault information 16 is received via the data line 9 connecting this control device 7 to the control unit 2, wherein the transmission of the fault information 16 can be understood as a transmission of a fault signal 17.

In the next step 13, fault control commands 18 are generated by the control unit 2 and transmitted to the control devices 7 via the data lines 9. In response to the presence of the fault signal 17, said signal transmission no longer takes place via the vehicle bus 4, which would not be possible due to its defect, but rather via the data lines 9, which realize a redundant communication link between the control unit 2 and the lighting devices 3 with respect to the vehicle bus 4. A plurality of possibilities are explained below with regard to the generation of the fault control commands 18 and their transmission via the data lines 9.

If the fault information 16 indicates that there is a line fault in the vehicle bus 4, which implies the presence of an accident involving the motor vehicle 1 or mechanical destruction of the vehicle bus 4, the fault control commands 18 cause a situation-specific fault lighting function to be implemented, namely a flashing warning light function. However, if the fault information 16 indicates that one of the parameters is not within the valid range, the fault control commands 18 are generated in such a way that they correspond to the control commands 15 that would be generated if the fault had not occurred. Consequently, in this case, the fault control commands 18 cause a lighting function realized by way of the control commands 15 before the defect of the vehicle bus 4 occurred to be continued.

In the final step 14, the control unit 2 uses the fault information 16 to initiate a targeted measure in order to at least reduce a risk associated with the defect in the vehicle bus 4 or to eliminate the defect. For this purpose, control signals 19 specifically provided for the respective fault information 16 are generated and output by the control unit 2. If the presence of an accident can be deduced from the fault information 16, the control signals 19 can trigger the automatic transmission of an emergency call. If a parameter is not within the valid range, the control signals 19 cause the vehicle bus 4 or the system for operating the vehicle bus 4 to be restarted so that the method can then be restarted from the beginning. In the event of a recurrence of the corresponding fault, the control signals 19 can also cause the generation of a user output, informing the driver of the presence of the fault and requesting a visit to a workshop.

German patent application no. 102025113607.6 filed April 7, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for maintaining a communication link between a control unit and lighting devices in a motor vehicle, wherein the motor vehicle includes the lighting devices and the control unit, wherein the control unit and each of the lighting devices are connected by a separate data line, the method comprising:
transmitting control commands generated by the control unit for controlling the lighting devices from the control unit to the lighting devices by a vehicle bus; and
transmitting, in the event of a defect in the vehicle bus, the control commands and/or fault control commands generated by the control unit for controlling the lighting devices to the respective lighting device via at least one of the data lines.

2. The method according to claim 1, wherein each of the lighting devices has a respective control device, by which at least one illuminant of the respective lighting device is controlled by the control commands and/or the fault control commands of the control device, and wherein the vehicle bus and the data lines connect the control unit to the control devices.

3. The method according to claim 1, further comprising:
checking the fulfillment of a fault condition, via at least one of the lighting devices, which is fulfilled if there is a defect in the vehicle bus;
generating a fault signal in the event of fulfillment of the fault condition;
transmitting the fault signal to the control unit via at least one of the data lines; and
causing the control commands and/or the fault control commands to be transmitted to the respective lighting device via the data line.

4. The method according to claim 3, further comprising:
carrying out an absence check regarding the control commands, wherein the fault condition is fulfilled if the absence check reveals that the control commands were not received by at least one of the lighting devices.

5. The method according to claim 3, further comprising:
carrying out a plausibility check regarding the control commands, wherein the fault condition is fulfilled if the plausibility check reveals a lack of plausibility in the control commands.

6. The method according to claim 5, further comprising:
checking, as part of the plausibility check, at least one parameter regarding the control commands to determine whether it is within a valid range, wherein the plausibility check reveals a lack of plausibility in the control commands if the at least one parameter is outside the valid range.

7. The method according to claim 6, wherein the at least one parameter is a voltage level of the control commands and/or a duty cycle of the control commands that are present as pulse-width modulated signals.

8. The method according to claim 3, further comprising:
determining, on the part of at least one of the lighting devices at least one fault information when the fault condition is fulfilled, which relates to a circumstance which is the cause of the defect in the vehicle bus; and
transmitting the at least one fault information to the control unit via at least one of the data lines.

9. The method according to claim 1, further comprising:
causing, by the fault control commands, a lighting function realized by the control commands before the defect of the vehicle bus occurred to be continued and/or a fault lighting function provided specifically for the defect of the vehicle bus to be implemented.

10. A motor vehicle, comprising a plurality of lighting devices and a control unit, wherein control commands generated by the control unit for controlling the lighting devices can be transmitted from the control unit to the lighting devices by a vehicle bus,
wherein the control device and each of the lighting devices are connected by a separate data line, and
wherein, in the event of a defect in the vehicle bus, the control commands and/or fault control commands generated by the control unit for controlling the lighting devices can be transmitted to the respective lighting device via at least one of the data lines.
